(19) United States
(12) Patent Application Publication
(10) Pub. No.: US 2008/0077807 A1
(43) Pub. Date: Mar. 27, 2008

(54) Computer Hard Disk Security

(75) Inventor: Richard Middleton Hicks, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED, London (GB)

(21) Appl. No.: 11/665,401

(22) PCT Filed: Oct. 6, 2005
(86) PCT No.: PCT/GB05/03826

§ 371 Date: Apr. 13, 2007

(30) Foreign Application Priority Data
Oct. 23, 2004 (GB) 0423559.4

(51) Int. Cl. G06F 12/14; H04L 9/28

(52) U.S. Cl. 713/193; 713/194

(57) ABSTRACT

Computer hard disk security comprises encrypting data on a computer's hard disk with a cryptographic key depending partly on computer memory contents, RAM and/or BIOS memory. Memory contents changing with time are excluded. The SHA-1 algorithm cryptographically hashes the memory contents giving a hash for XORing with a user password. XORing provides a result which is used as a password for an encryption unit implementing a conventional full disk encryption technique, such as XORing the password with a hard disk dock number. The key is generated with the BIOS memory configured so that the computer boots only from the hard disk. Hostile alteration of the BIOS memory contents results in failure to decrypt because the key now cannot be used to decrypt the hard disk. This defeats an attacker who alters BIOS settings in an attack with rogue computer boot media such as a floppy disk or a CD ROM.

This invention relates to a method, an apparatus and computer software for computer hard disk security.

With use of computers becoming widespread, there is a growing problem of loss of data from computer hard disks. It is known to protect data on a computer at times when the computer is in use by requiring a computer user to enter a password before software on the computer's hard disk grants access to the data. Some operating systems may be configured in accordance with an intention that computer users only have restricted data access, i.e. access to some but not all of the data on the disk: for example, users may not be able to alter any vital operating system file and configuration information. The combination of a password and restricted data access is intended to protect the data both while the computer is switched on and also when it is switched off.

To protect data against loss or theft and other perils, data encryption is often used. Some encryption techniques only encrypt files or groups of files: these techniques, although often cheap, do not provide adequate protection. For example, a thief may steal a computer, surreptitiously add malicious software which records a bona fide computer user's password, and return the computer to the user without the computer's absence being detected. Upon the bona fide computer user entering his password, the password is captured by the malicious software. The thief can then steal the computer once more and use the captured password to obtain full access to data on the computer. Additionally, temporary or “work” files may be created that are not encrypted and not fully deleted from the hard disk. An attacker who steals the computer can potentially be able to read data in work files.

GB2264373A discloses encrypting data blocks for storage using different keys derived from a common key as a function of storage location.

EP 0855652 A1 discloses a method for maintaining data integrity by generating an access key from a designated part of data requiring preservation. The access key is then used for encoding. It may be generated from a condensed version of data obtained cryptographically from uncondensed data. A reading key may be used to generate the access key.

EP 0455064 A2 discloses encrypting data using an encryption key consisting of data bytes at a key address in a memory. The key is used to encrypt all data in the memory.

US 2003/0140239 A1 discloses encryption key generation from key information common to recording blocks on a recording medium and further key information unique to each to recording block.

US 2002/0131595 A1 discloses a method for encrypting data in continuous unit blocks in a precedence order one block at a time. A seed for an encryption key for one unit block is derived from one or more preceding blocks.

Improved encryption techniques are known that encrypt whole partitions on a computer hard disk, and may encrypt all but the Master Boot Record. With such techniques all work files are automatically encrypted but there still exists a risk of a password being captured by an attacker using malicious software. As an example, data can be read in many cases by an attacker who boots the computer using a floppy disk instead of the computer's hard disk, thereby bypassing all software controls that would have been in place if the computer were to have been booted normally.

Full disk encryption products are commercially available which eliminate the threat of malicious software being installed as described above. Such a product replaces a computer's hard disk with new hardware which is equivalent to a combination of a physically smaller hard disk and an encryption unit which performs encryption and decryption. It has the same size and electrical interface as a conventional hard disk but has a cryptographic function built-in. The exact installation method is product dependent. When the computer is booted, the new hardware in the product modifies the boot sequence and requests a valid password or equivalent. If the valid password or equivalent is entered, the new hardware notes the fact that a valid password has been entered and reboots the computer. Upon reboot, the new hardware becomes effectively transparent to data flow and appears to be an unencrypted hard disk as far as communication with the rest of the computer is concerned.

Data on the product's hard disk is initially encrypted using a cryptographic key is entered into the encryption unit: the key is used to perform encryption and decryption that is a function of security information such as a password or passphrase entered by the user and potentially other information too.

However, full disk encryption products can be overcome by an attacker who has learnt (stolen) the encryption unit password (e.g. by covertly observing a bona fide computer user entering the password). The attacker enters the stolen password and waits for the computer to start the process of rebooting. While the computer is rebooting, the attacker can insert rogue boot media such as a floppy disk or a CD ROM into the computer and then gain access to the entire hard disk, thus bypassing all software access controls implemented by a normal boot operation. It is an object of the present invention to provide protection against such an attacker.

The present invention provides a method for computer hard disk security characterised in that it incorporates the step of encrypting data on a computer's hard disk with a cryptographic key which is derived at least partly from contents of the computer's memory not expected to change with time.

The invention provides the advantage that, with a binary input output system (BIOS) memory configured so that the computer boots only from the hard disk, hostile alteration of the BIOS memory contents results in failure to decrypt because the key cannot now be used to decrypt the hard disk. This defeats an attacker who alters BIOS settings using rogue computer boot media.

The memory areas which are excluded from cryptographic key derivation may be those indicated to have variable contents by memory scanning. They may include those having real-time clocks and hardware status registers.

The method may incorporate the steps of:
a) deriving the cryptographic, key by cryptographically hashing contents of at least one of the computer's random access memory (RAM) and binary input-output system (BIOS) memory to produce a hash, and
b) combining the hash with security information (e.g. a password) entered by a user of the computer.

The step of combining the hash with security information may involve an exclusive OR (XOR) of the hash with the security information and providing an XOR result for use as a password in a full disk encryption process. The XOR result password may be XORed with a block number of the hard disk to provide a cryptographic key for use with an encryption/decryption algorithm to encrypt or decrypt data on the hard disk.

In another aspect, the present invention provides computer apparatus for hard disk security, the computer apparatus being programmed to implement the step of encrypting data on a computer's hard disk with a cryptographic key which is derived at least partly from contents of the computer's memory not expected to change with time.

The computer apparatus may be programmed to exclude from cryptographic key derivation memory areas which are indicated by memory scanning to have variable contents, such as those having real-time clocks and hardware status registers.

The computer apparatus may be programmed to carry out the steps of:
a) deriving the cryptographic key by cryptographically hashing contents of at least one of the computer's RAM and BIOS memory to produce a hash, and
b) combining the hash with security information (e.g. a password) entered by a user of the computer.

The computer apparatus may be programmed to carry out the step of combining the hash with security information by an exclusive OR (XOR) of the hash with the security information and providing an XOR result for use as a password in a full disk encryption process.

The computer apparatus may be programmed to carry out the steps of:
a) XORing the XOR result password with a block number of the hard disk to provide a cryptographic key, and
b) using the cryptographic key with an encryption/decryption algorithm to encrypt or decrypt data on the hard disk.

In a further aspect, the present invention provides computer software for computer hard disk security, the computer software containing instructions for controlling computer apparatus to implement the step of encrypting data on a computer's hard disk with a cryptographic key which is derived at least partly from contents of the computer's memory not expected to change with time.

The computer software may contain instructions for controlling computer apparatus to exclude from cryptographic key derivation memory areas which are indicated by memory scanning to have variable contents, such as those having real-time clocks and hardware status registers. It may have instructions for deriving the cryptographic key by cryptographically hashing contents of at least one of the computer's RAM and BIOS memory to produce a hash, and combining the hash with security information (e.g. a password) entered by a user of the computer. It may be arranged to provide for combining the hash with security information by an exclusive OR (XOR) of the hash with the security information and providing an XOR result for use as a password in a full disk encryption process. It may contain instructions for XORing the XOR result password with a block number of the hard disk to provide a cryptographic key, and using the cryptographic key with an encryption/decryption algorithm to encrypt or decrypt data on the hard disk.

In order that the invention might be more fully understood, an embodiment thereof will now be described, by way of example only, with reference to the accompanying drawings, in which:

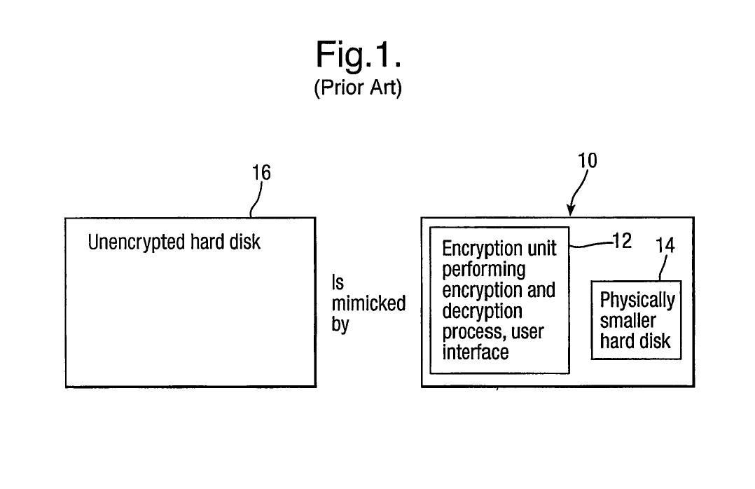

FIG. 1 is a simplified schematic block diagram of a prior art conventional hard disk and a full disk encryption product which replaces it; and

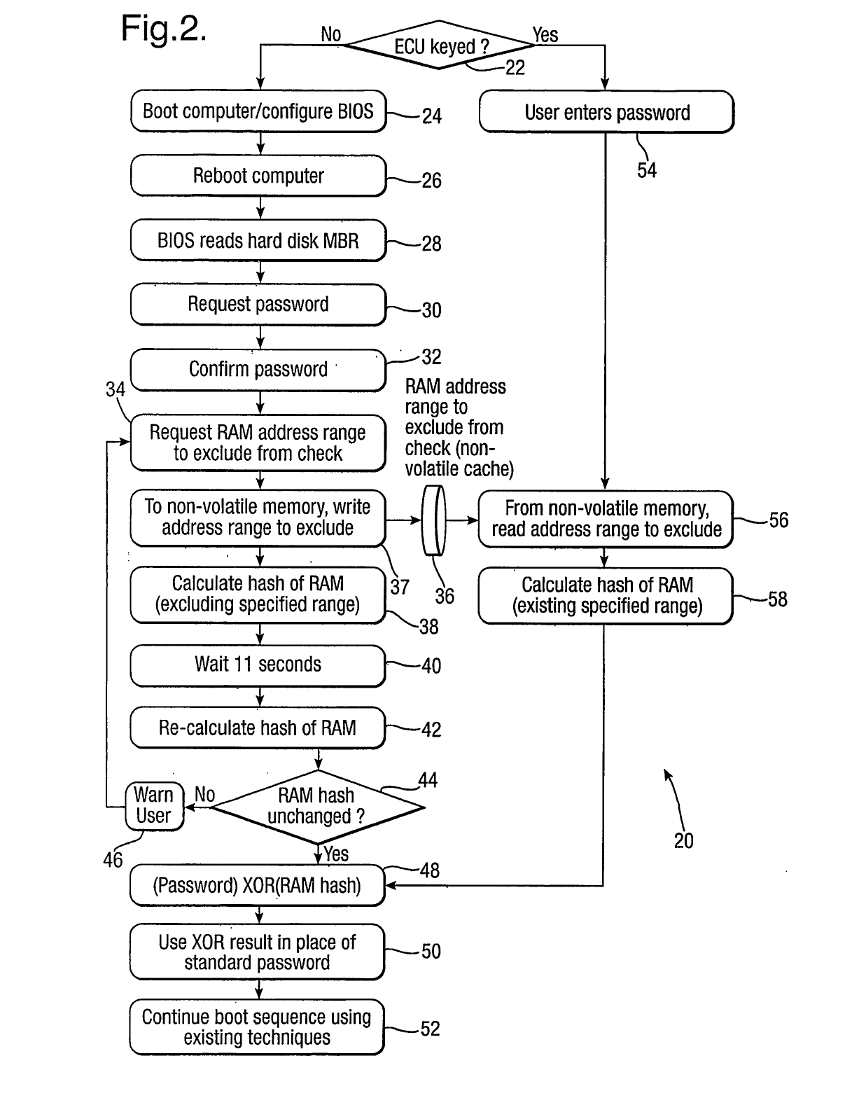

FIG. 2 is a flow diagram of a cryptographic, computer-implemented, hard disc security technique of the invention for use with the FIG. 1 product.

The invention will first be outlined, and then an example described in more detail. Referring to FIG. 1, a full disk encryption product 10 for use in a computer (not shown) contains an encryption unit 12 for encrypting and decrypting data with a cryptographic key. It also contains a physically smaller hard disk 14 compared to a conventional hard disk 16 which the product 10 replaces and mimics.

Data on the smaller hard disk 14 is encrypted by the encryption unit 12 using a method described in more detail below: to implement encryption, a cryptographic key is entered into the encryption unit 12, the key being a function of a computer user's security information such as a password or passphrase entered by the user and possibly other information also. In accordance with the invention, the key is constructed in such a way that it depends at least partly on contents of the computer's memory. The contents of the computer's random access memory (RAM) are cryptographically hashed: this produces a hash with a length suitable for combining with security information entered by the user. The hash and security information are combined in such a way that the cryptographic key used to protect data on the hard disk depends on the RAM contents. The RAM can be expected to have contents which are at least partially constant as a result of early states of a computer boot sequence that initialises and checks the RAM. Any such contents which are not constant are excluded from the hash operation.

Computers also have a binary input-output system (BIOS) memory having fixed contents which may advantageously be included in the process of generating the cryptographic key. As a result, provided that the key was initially generated with the BIOS memory configured to require the computer to boot only from the hard disk, any alteration of the BIOS memory contents results in the encryption unit 12 being given the wrong key to decrypt the information on the hard disk 14, resulting in failure to decrypt. The net result of this is that it defeats an attacker who alters BIOS settings to attempt a boot attack using rogue boot media such as a floppy disk or a CD ROM inserted into the computer. Consequently the invention provides protection against there being a gap in security between a hard disk 14 being booted and an operating system providing security.

Memory areas which are variable are excluded from the hashing process, e.g. an area of memory with real-time clocks and hardware status registers. Areas of memory that are known to change may be eliminated automatically by scanning computer memory and noting which areas of it have variable contents.

An example of the invention will now be described in more detail. Referring now also to FIG. 2, this shows a flow diagram of a cryptographic, computer-implemented, hard disc security technique 20 of the invention for use in connection with the full disk encryption product 10 assembled into a computer (not shown). The technique 20 has a first stage 22 at which a check is made regarding whether or not a cryptographic key is contained in the encryption unit (ECU) 12: there is a variety of possible checks in this regard, one such being to check whether or not a flag is set to indicate presence of the key. If the encryption unit (ECU) 12 does not contain a key, at 24, an installer, i.e. a person responsible for software installation, then boots up the computer and configures the computer's BIOS to boot only from the hard disk 14. The installer also makes any other required changes to the BIOS and reboots the computer at 26. The BIOS runs and issues the command to read the master boot record (MBR) from the hard disk at 28. The encryption unit 12 responds by using software to:
a) ask for password at 30;
b) request password confirmation at 32 to ensure that the computer's user has entered it correctly;
c) ask the user for a RAM address range which is to be excluded from subsequent checking at 34. The user enters the RAM address range where the Time of Day clock value is stored and which therefore gives rise to volatile RAM contents in this range;
d) write the excluded RAM address range to non-volatile memory 36 at stage 37;
e) calculate at 38 a hash of the entire RAM memory except for the RAM address range excluded at 34/36: this calculation uses the publicly available SHA-1 algorithm,
f) wait 11 seconds at 40 (this is not critical, and any time in excess of 1 second may be adequate in many cases: here the objective is to ensure a change occurs in the computer's system clock so that stage 44 below operates correctly);
g) recalculate the memory hash at 42;
h) compare at 44 the hash value recalculated at 42 with the hash value previously calculated at 38;
i) warn the user at 46 that the hash is not constant if the hash values calculated at 38 and 42 are different, and loop back to repeat request for excluded RAM address range and to iterate stages 34 to 44;
j) continue processing at 48 (if the hash values calculated at 38 and 42 are the same) by calculating an exclusive OR (XOR) of the password with the hash value;
k) at 50 use the XOR result from 48 as a password in subsequent processing below instead of the user password entered at 54 which would have been so used if this invention was not implemented; and
l) continue processing at 52 using one of a variety of prior art full disk encryption techniques: a simplified example of a prior art full disk encryption technique begins by requesting a user to enter a password, and XORs the password from 48 with a block number of the disk 14. In the present case, as previously indicated the password generated at 48 is used instead of the user password. The XOR process at 52 yields a result which is used as a key to an encryption/decryption algorithm such as AES, and a block of data to be encrypted or decrypted is also input to the crypto algorithm. Checks are then made regarding whether the system is decrypting or encrypting and whether this is the first encryption or normal use. The form of these checks is dependent on which prior art technique is used.

If at 22 it is found that a cryptographic key is contained in the encryption unit (ECU) 12, then another process is followed. The encryption unit 12 responds to the presence of a key by using software to:
a) accept a user's password at 54;
b) read the excluded RAM address range at 56 from the non-volatile memory 36;
c) use the publicly available SHA-1 algorithm at 58 to calculate a hash of all the RAM memory contents excluding the RAM address range in non-volatile memory 36;
d) return to step 48 and XOR together the user's password input at 54 and the hash calculated at 58 to generate an XOR result;
e) use the XOR result from 48 at 50 as a password in subsequent processing below instead of the user password entered at 54 which would have been so used if this invention was not implemented; and
f) continue processing at 52 using prior art full disk encryption techniques.

1. A method for computer hard disk security incorporating the steps of:
a) deriving a cryptographic key at least partly from contents of a memory of computer apparatus, such contents being of a kind which are not expected to change with time, and
b) encrypting data on a hard disk of the computer apparatus using the cryptographic key.

2. A method according to claim 1 wherein the computer apparatus memory has memory areas indicated by memory scanning to have variable contents, and such memory areas are excluded from cryptographic key derivation.

3. A method according to claim 2 wherein the memory areas having variable contents and thereby excluded from cryptographic key derivation include those having real-time clocks and hardware status registers.

4. A method according to claim 1 wherein the computer apparatus memory incorporates random access memory (RAM) and binary input-output system (BIOS) memory, and the method incorporates the steps of:
a) deriving the cryptographic key by cryptographically hashing contents of at least one of the RAM and BIOS memory to produce a hash, and
b) combining the hash with security information entered by a user of the computer apparatus.

5. A method according to claim 4 wherein the security information is a password.

6. A method according to claim 4 wherein the step of combining the hash with security information involves an exclusive OR (XOR) of the hash with the security information and providing an XOR result.

7. A method according to claim 4 including using the XOR result as a password in a full disk encryption process.

8. A method according to claim 7 incorporating the steps of:
a) XORing the XOR result password with a block number of the hard disk to provide a cryptographic key, and
b) using the cryptographic key with a encryption/decryption algorithm to encrypt or decrypt data on the hard disk.

9. Computer apparatus for hard disk security, the computer apparatus being programmed to implement the steps of:
a) deriving a cryptographic key at least partly from contents of a memory of the computer apparatus, such contents being of a kind which are not expected to change with time, and
b) encrypting data on a hard disk of the computer apparatus using the cryptographic key.

10. Computer apparatus according to claim 9 having memory areas indicated by memory scanning to have variable contents, and the computer apparatus is programmed to exclude such memory areas from cryptographic key derivation.

11. Computer apparatus according to claim 10 wherein the memory areas having variable contents and thereby excluded from cryptographic key derivation include those having real-time clocks and hardware status registers.

12. Computer apparatus according to claim 9 having RAM and BIOS memory and programmed to carry out the steps of:
a) deriving the cryptographic key by cryptographically hashing contents of at least one of the RAM and BIOS memory to produce a hash, and
b) combining the hash with security information entered by a user of the computer apparatus.

13. Computer apparatus according to claim 12 wherein the security information is a password.

14. Computer apparatus according to claim 12 programmed to carry out the step of combining the hash with security information by an exclusive OR (XOR) of the hash with the security information and providing an XOR result.

15. Computer apparatus according to claim 12 programmed to use the XOR result as a password in a full disk encryption process.

16. Computer apparatus according to claim 15 programmed to carry out the steps of:
a) XORing the XOR result password with a block number of the hard disk to provide a cryptographic key, and
b) using the cryptographic key with an encryption/decryption algorithm to encrypt or decrypt data on the hard disk.

17. A computer program product for computer hard disk security and comprising a computer-readable medium embodying program code instructions for execution by a computer processor, wherein the instructions are for controlling computer apparatus to implement the steps of:
a) deriving a cryptographic key at least partly from contents of a memory of the computer apparatus, such contents being of a kind which are not expected to change with time, and
b) encrypting data on a hard disk of the computer apparatus using the cryptographic key.

18. A computer program product according to claim 17 wherein the computer apparatus memory has memory areas indicated by memory scanning to have variable contents, and the instructions are also for controlling the computer apparatus to exclude such memory areas from cryptographic key derivation.

19. A computer program product according to claim 18 wherein the memory areas having variable contents and for exclusion from cryptographic key derivation include those having real-time clocks and hardware status registers

20. A computer program product according to claim 17 wherein the computer apparatus has RAM and BIOS memory and the instructions are also for controlling the computer apparatus to implement the steps of:
a) deriving the cryptographic key by cryptographically hashing contents of at least one of the RAM and BIOS memory to produce a hash, and
b) combining the hash with security information entered by a user of the computer apparatus.

21. A computer program product according to claim 20 wherein the security information is a password.

22. A computer program product according to claim 20 wherein the instructions are also for controlling computer apparatus to carry out the step of combining the hash with security information by an exclusive OR (XOR) of the hash with the security information and providing an XOR result.

23. A computer program product according to claim 20 wherein the instructions are also for controlling computer apparatus to use the XOR result as a password in a full disk encryption process.

24. A computer program product according to claim 23 wherein the instructions are also for controlling computer apparatus to carry out the steps of:
a) XORing the XOR result password with a block number of the hard disk to provide a cryptographic key, and
b) using the cryptographic key with an encryption/decryption algorithm to encrypt or decrypt data on the hard disk.
